(19) United States
(12) Patent Application Publication
(10) Pub. No.: US 2006/0224756 A1
(43) Pub. Date: Oct. 5, 2006

(54) System and method for error recovery for massive exit in peer-to-peer network

(76) Inventors: Mingjian Yu, Beijing (CN); Xiangyang Chen, Beijing (CN)

Correspondence Address: HAYNES AND BOONE, LLP, 901 MAIN STREET, SUITE 3100, DALLAS, TX, 75202, US

(21) Appl. No.: 11/154,188

(22) Filed: Jun. 16, 2005

Related U.S. Application Data
(60) Provisional application No. 60/662,131, filed on Mar. 15, 2005.

(51) Int. Cl. G06F 15/16

(52) U.S. Cl. 709/231

(57) ABSTRACT

A method, computer-readable medium and data processing system for randomizing termination of peer services in a peer-to-peer network is provided. A streaming media application receives a close command and closes a media player in response thereto. A randomized delay time is obtained by the streaming media application. The streaming media application maintains peer services until expiration of the randomized delay time.

### RELATED APPLICATION DATA

This patent application claims the benefit of provisional U.S. patent application Ser. No. 60/662,131, filed Mar. 15, 2005.

Additionally, this application is also related to commonly assigned U.S. patent application No. ______ , filed concurrently herewith, Attorney Docket No. 33189.11, entitled “SYSTEM AND METHOD FOR STREAMING SERVICE REPLICATION IN A PEER-TO-PEER NETWORK,” which is incorporated herein by reference.

### BACKGROUND

In a client-server network adapted to provide streaming multimedia data such as video or audio, many clients may participate in a video streaming session. The capacity of a media server in such a network is generally limited. If the number of clients connected to the media server exceeds the processing or transmission capacity of the server, the media server may be unable to provide a high quality of service to the clients, crash, discontinue service to clients, or refuse service or connection to clients.

Peer-to-peer networking solutions reduce or eliminate capacity deficiencies that are common in client/server network configurations. A conventional peer-to-peer multimedia streaming network includes a source server that provides streaming content, a control server which organizes the clients participating in a streaming session, and various clients. Clients in the peer-to-peer network may query other clients for streaming data and provide cached data to other clients.

When a client exits from a peer-to-peer network, any other clients that have a relation to the newly disconnected client must terminate their connection with the disconnected client and may need to establish a new connection with another client. Thus, the network architecture is dynamically changed. Problematically, when a streaming transmission is live broadcast, clients will often disconnect near the end of a streaming program transmission thus resulting in a massive, or high quantity, exit. Clients that desire to remain active in the streaming session, e.g., for viewing a subsequent streaming program transmission, may experience various problems, such as loss of connectivity, poor transmission quality, or other problems related to the number of clients that have left the network.

### BRIEF DESCRIPTION OF THE DRAWINGS

Aspects of the present disclosure are best understood from the following detailed description when read with the accompanying figures, in which:

FIG. 1 is a diagram of an embodiment of a peer-to-peer network that may feature embodiments of randomized peer service terminations;

FIG. 2 is a client exit rate plot that shows an exit rate anomaly resulting from a massive exit of clients from a peer-to-peer network;

FIG. 3 is a diagram of an embodiment of a client software configuration for providing randomized termination of peer services in a peer-to-peer network;

FIG. 4 is a flowchart of an embodiment of processing performed by a streaming media application for randomizing termination of peer services;

FIG. 5 is a flowchart of another embodiment of processing performed by a streaming media application for providing persistent media services to peer clients;

FIG. 6 is a flowchart of an embodiment of processing performed by a streaming media application for randomizing the termination of peer services under direction of a control server;

FIG. 7 is a client exit rate plot that shows a reduced peak client exit rate achieved by implementing embodiments of randomized peer service termination; and

FIG. 8 is a simplified block diagram of an embodiment of a computer system that may be configured to implement randomized termination of peer services.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

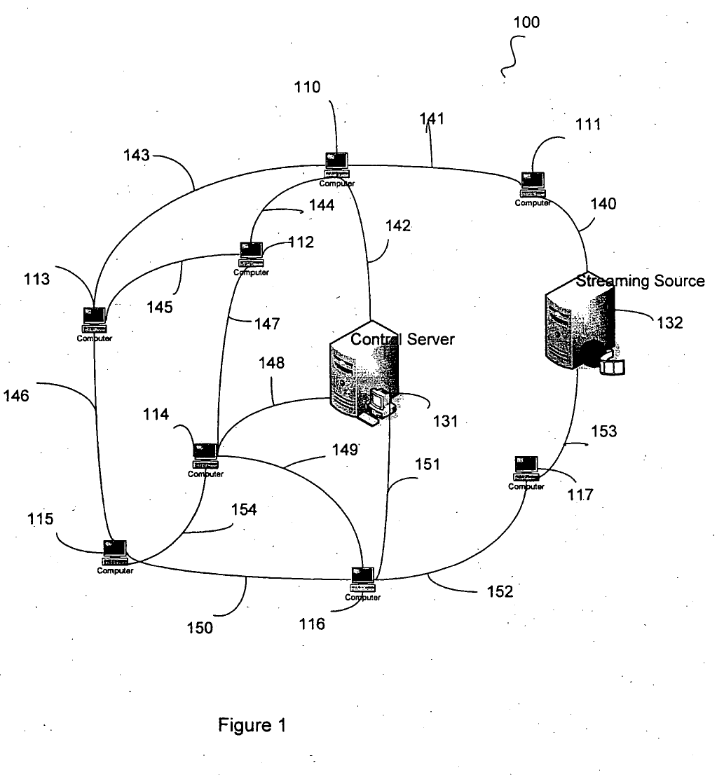

FIG. 1 is a diagram of an embodiment of a peer-to-peer network 100 that may feature randomized termination of peer services. Network 100 includes various clients 110-117 that may be interconnected with other clients in network 100. Additionally, network 100 may include a control server 131 and a streaming source 132. One or more clients may connect with control server 131 and streaming source 132 in addition to other network clients. Clients 110-117 may connect with other network clients, control server 131, and streaming source 132 by network connections 140-154, such as wire, wireless communication links, fiber optic cables, or other suitable network media.

Control server 131 may organize clients 110-117 that have joined network 100. Streaming source 132 may be implemented as a server that stores or accesses data, such as video, audio, or the like, and streams the data to clients in network 100. Clients 110-117 may be implemented as data processing systems, such as personal computers, wired or wireless laptop computers, personal digital assistants, or other computational devices capable of network communications. Clients 110-117 may query for streaming data and stream cached data to other clients. For example, client 117 may download streaming content from streaming source 132 and may upload the streaming content to client 116. Client 116 may, in turn, provide the streaming content (or a portion thereof) to other network clients, such as client 114 and 115. As referred to herein, a peer service may comprise an upload of streamed or cached content to a peer client for consumption, e.g., playback, by the peer or for the peer client to transfer the uploaded content to another network client.

Network 100 may comprise a transient Internet network, and thus clients 110-117, control server 131, and streaming source 132 may use the Transmission Control Protocol/Internet Protocol (TCP/IP) suite of protocols to communicate with one another. Alternatively, network 100 may be implemented in any number of different types of networks, such as for example, an intranet, a local area network (LAN), or a wide area network (WAN). FIG. 1 is intended as an example, and not as an architectural limitation of embodiments described herein.

When a client exits network 100, peers of the client that has exited may need to connect with one or more other remaining network clients to maintain similar streaming quality. For example, assume client 112 disconnects or otherwise leaves network 100. One or more peer clients 110, 113, and 114 previously connected with client 112 may need to establish connections with other clients remaining in network 100 to maintain an acceptable streaming quality.

Periodically, a large number of clients may exit network 100 within a short span of time. For example, streaming source 132 may provide a sequence of live program transmissions. Clients may connect with network 100 to view or otherwise consume a particular program transmission. A large number of these clients may exit network 100 during a short time period that includes the interval between sequential programs of the streaming transmission. For example, a large number of clients may exit network 100 near the end of a program during closing credits thereof. Such a group exit from network 100 is herein referred to as a massive exit. A massive exit tends to destabilize network 100 and can degrade and interrupt streaming transmission to other clients remaining, or attempting to remain, connected within network 100.

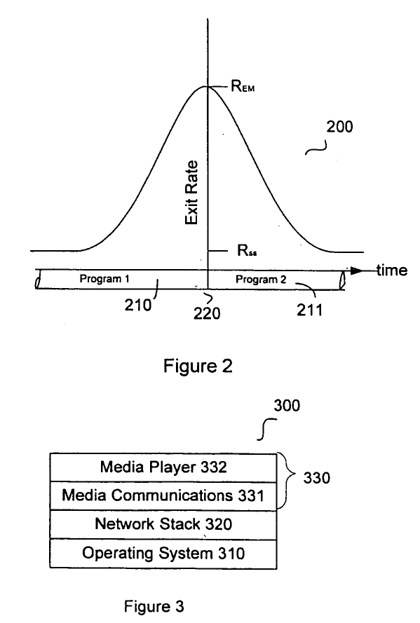

FIG. 2 is a client exit rate plot 200 that shows an exit rate anomaly resulting from a massive exit of clients from a peer-to-peer network during, or in close proximity to, a transition of a first program to a second program in a streaming transmission. A streaming transmission 220 may include multiple programs 210-211, such as different video broadcasts, news broadcasts, concerts, or other streaming content. During the normal operations of network 100, clients will disconnect from network 100 at or near a steady state exit rate (Rss). However, as the end of a program of the streaming transmission nears, the number of clients that will exit increases. For example, in a live streaming transmission of a program, the rate of client exits may significantly increase when end credits begin being streamed. In the illustrative example, an increase in the exit rate continues until a maximum exit rate (R_{EM}) is reached. The exit rate may then return to or approach the steady state exit rate. Network 100 may operate under significant distress during the increased client exit rate, and the transmission quality, such as the quality of an initial part of a program 211, may be degraded to clients in network 100.

Embodiments described herein provide mechanisms for diffusing client exits over a more extended time period. A random interval may be generated or otherwise obtained by a client in response to an exit or disconnect command received by the client. A playback module of a streaming media application is closed in response to the disconnect command. Shutdown of a media communications module that handles peer connections of the media streaming application is delayed for the random interval. In this manner, the disconnection of clients in network 100 is randomized, and the exit of clients from network 100 may be diffused over a period of time. Advantageously, the peak exit rate is reduced thereby stabilizing network 100 performance.

FIG. 3 is a diagram of an embodiment of a client software configuration 300 for providing randomized termination of peer services in a peer-to-peer network. Software configuration 300 comprises sets of computer-executable instructions or code that may be fetched from a memory and executed by a processing unit of a data processing system.

Software configuration 300 may include an operating system 310, such as a Windows operating system manufactured by Microsoft Corporation of Redmond, Wash., an OS/2 operating system manufactured by International Business Machines Corporation of Armonk, N.Y., or the like. Operating system 310 may include a network stack 320 for effecting network communications. For example, network stack 320 may be implemented as a transmission control protocol/Internet protocol (TCP/IP) stack. A streaming media application 330 may include a media communications module 331 and a player module 332. Media communications module 331 interfaces with network stack 320 and provides for management of peer connections. For example, media communications module 331 may maintain socket data of peer connections, retrieval functions of data cached by the client for transmission to another client, or other functions that facilitate the client downloading or uploading media data from or to other clients or system servers. Player module 332 comprises logic for processing and playback of streaming data, such as streaming video, audio, or other streaming content. In accordance with embodiments described herein, media player module 332 is closed in response to streaming media application 330 receiving a close command, for example from a user input device such as keyboard or mouse. Termination of media communications module 331 may be delayed a random interval after receipt of the close command. In this manner, peer downloads serviced by the client are maintained during the delay interval. In a network featuring numerous clients configured in such a manner, the randomized delay at which peer services are terminated acts to diffuse client exits from the peer-to-peer network over a period of time such that a maximum rate of client exits is reduced.

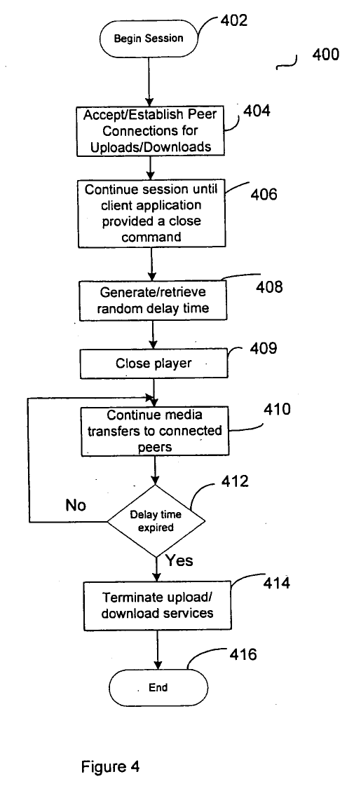

FIG. 4 is a flowchart of an embodiment of processing performed by streaming media application 330 shown in FIG. 3 for randomizing termination of peer services. The media session is started (step 402), for example upon execution of a streaming media application executable file. The client may then accept and establish peer connections for uploading data to peer clients and downloading data therefrom (step 404). Media player module 332 may begin playback of streaming data upon establishment and receipt of streaming media from another peer client. The session is continued until the client application receives a close command (step 406), for example a close command provided by a user to an input device. In response to receiving a close command, streaming media application 330 may generate or otherwise obtain a random delay time (step 408). For example, streaming media application 330 may include a pseudo-random generator as a set of instructions that are invoked on receipt of the close command. Media player module 332 is then closed (step 409), and data transfers to other peer clients are maintained by media communications module 331 (step 410). An evaluation is made to determine if the delay time has expired (step 412). In the event the delay time has not expired, streaming media application 330 processing continues providing media transfers to peer clients according to step 410. On expiration of the delay timer, streaming media application 330 terminates peer connections, for example by terminating media communications module 331 (step 414). Streaming media application 330 processing then ends (step 416).

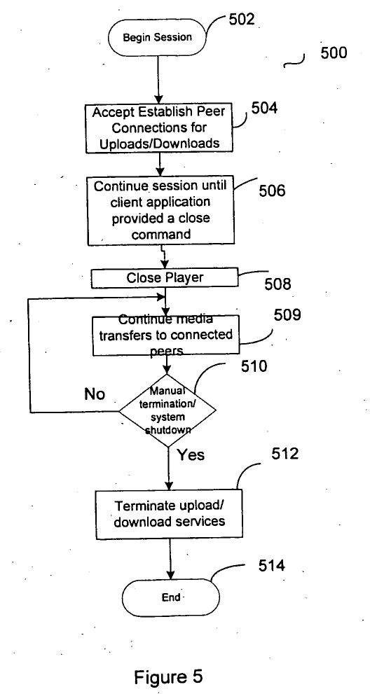

FIG. 5 is a flowchart 500 of another embodiment of processing performed by streaming media application 330 shown in FIG. 3 for providing persistent media services to peer clients. The media session is started (step 502), for example upon execution of a streaming media application executable file. The client may then accept and establish peer connections for uploading and downloading data to and from peer clients (step 504). Media player module 332 may begin playback of streaming data upon establishment and receipt of streaming media from another peer client. The session is continued until the client application receives a close command (step 506). In response to receiving a close command, media player module 332 is closed (step 508), and data transfers are continued to other connected peer clients (step 509). An evaluation may then be made to determine if a manual termination or system shutdown has been invoked (step 510). In the event a manual termination or system shutdown has not been invoked, streaming media application 330 processing continues providing media transfers to peer clients according to step 509. Once a manual termination or system shutdown is invoked, streaming media application 330 terminates peer connections, for example by terminating media communications module 331 (step 512). Streaming media application 330 processing then ends (step 514). Thus, in the embodiment of streaming media application 330 processing depicted in FIG. 5, a user may terminate playback of a streaming media session. The streaming media application continues providing data transfer services to peer clients until provided a manual command by the user to disconnect any connected peer clients or until the computer system is shut down.

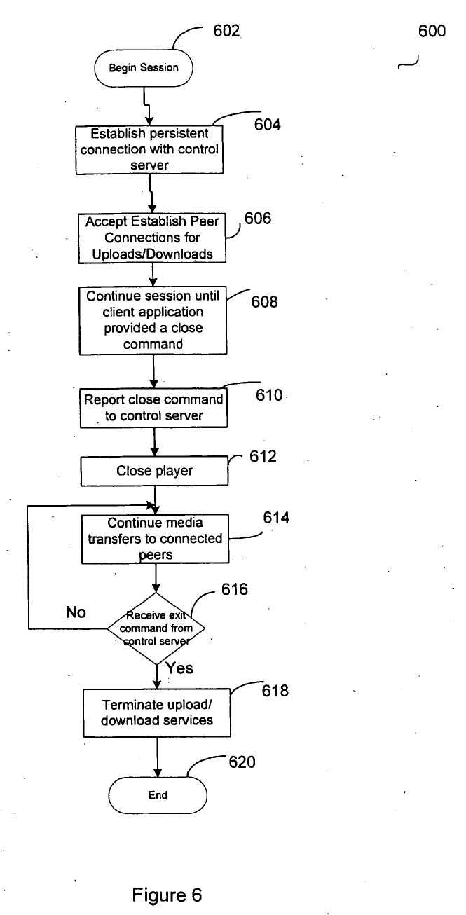

FIG. 6 is a flowchart of an embodiment of processing performed by streaming media application 330 for randomizing the termination of peer services under the direction of a control server. The media session is started (step 602), for example upon execution of a streaming media application executable file. The client then establishes a persistent connection with control server 131 (step 604). The client may then accept and establish peer connections for uploading and downloading data to and from peer clients (step 606). Media player module 332 may begin playback of streaming data upon connection establishment and receipt of streaming media from another peer client. The session is continued until the client application receives a close command (step 608). In response to receiving a close command, streaming media application 330 may report receipt of the close command to control server 131 (step 610). Media player module 332 may then be closed (step 612), and data transfers to other peer clients are maintained by media communications module 331 (step 614). An evaluation may then made to determine if an exit command has been received from control server 131 (step 616). In the event control server 131 has not provided the client with an exit command, streaming media application 330 processing continues providing media transfers to connected clients according to step 614. Once an exit command is received from control server 131, streaming media application 330 terminates peer connections, for example by terminating media communications module 331 (step 618). Streaming media application 330 processing then ends (step 620). Thus, in the embodiment of streaming media application 330 processing depicted in FIG. 6, a control server may provide client exit commands in a manner that randomizes termination of peer services in a peer-to-peer network.

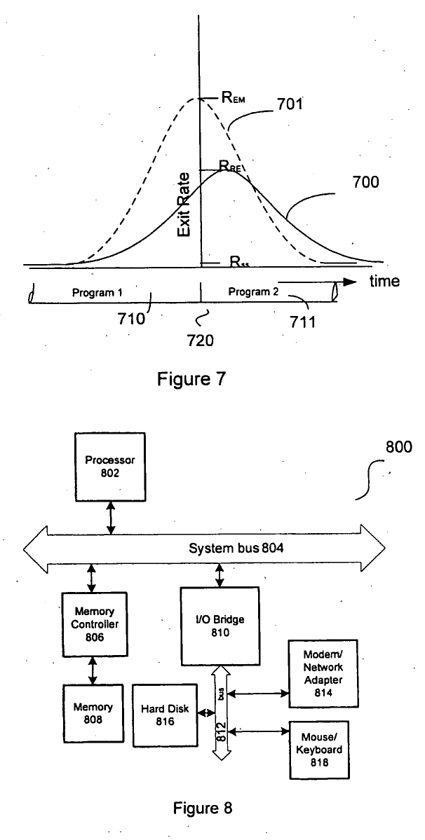

FIG. 7 is a client exit rate plot 700 that shows a reduced peak client exit rate achieved by implementing embodiments of randomized peer service termination. A streaming transmission 720 may include multiple programs 710-711, such as different video broadcasts, news broadcasts, concerts, or other streaming presentations. As discussed above, clients may periodically terminate session playback in network 100 at an increased rate for various reasons. Such an exit rate is shown by a plot 701 of an increased exit rate characterized by a maximum exit rate (R_{EM}). Embodiments described herein provide for randomizing termination of peer services. Randomization of the termination of peer services results in an exit rate that is diffused over a larger period of time and is characterized by a maximum randomized exit rate (R_{RE}) that may be less than a non-randomized peak exit rate, e.g., a maximum exit rate R_{EM}. Additionally, randomization of peer service termination may result in a delay of the peak exit rate of clients from the peer-to-peer network. The peak exit rate may be further reduced by implementing a persistent services mode as described above in FIG. 5. In such an implementation, the client exit rate may approach the steady state exit rate Rₛₛ.

FIG. 8 is a simplified block diagram of an embodiment of a data processing system 800, such as client 110 shown in FIG. 1, that may be configured to implement randomized termination of peer services. One or more of clients 111-117 may be configured similar to data processing system 800. Data processing system 800 includes a processor 802 interconnected with a system bus 804. System bus 804 provides couplings to subsystems and components of data processing system 800. A memory controller 806 interconnected with a system memory 808 provides a communicative coupling between memory 808 and processor 802. Memory 808 may store executable instructions that provide randomized termination of peer services as described more fully below. An input/output (I/O) bridge 810 may be connected with system bus 804, and one or more input/output devices may be connected with an I/O bus 812. For example, a hard disk 816 may provide non-volatile storage, and a modem or network adapter 814 may provide an interface to a communication medium that facilitates data exchanges between data processing system 800 and one or more clients in network 100. Additionally, user input devices, such as a mouse/keyboard 818, that facilitate user input to data processing system 800 may be coupled with I/O bus 812. The configuration of data processing system 800 is illustrative of an exemplary peer-to-peer network client and is chosen only to facilitate an understanding of embodiments described herein.

Embodiments described herein provide mechanisms for diffusing client exits from a peer-to-peer network over an extended time period. A random interval may be generated or otherwise obtained by a client in response to an exit or disconnect command received by the client. A playback module of a streaming media application is closed in response to the disconnect command. Shutdown of a media communications module that handles peer connections of the media streaming application is delayed for the random interval. In this manner, the disconnect of clients in network 100 is randomized, and the exit of clients in network 100 may be diffused over a period of time. Advantageously, the peak exit rate is reduced thereby stabilizing network 100 performance.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of randomizing termination of peer services in a peer-to-peer network, comprising:
receiving, by a streaming media application, a close command;
responsive to receiving the command, closing a media player;
obtaining, by the streaming media application, a randomized delay time; and
maintaining, by the streaming media application, peer services until expiration of the randomized delay time.

2. The method of claim 1, wherein obtaining the randomized delay time comprises generating, by the streaming media application, the randomized delay time.

3. The method of claim 1, further comprising:
establishing, by the streaming media application, a connection with a control server; and
generating, by the control server, the randomized delay time.

4. The method of claim 3, wherein obtaining the randomized delay time comprises receiving the randomized delay time from the control server.

5. The method of claim 3, further comprising reporting, by the streaming media application, the close command to the control server.

6. The method of claim 3, wherein the control server receives a respective close command from each of a plurality of clients running an instance of the streaming media application and generates a respective randomized delay time for each of the plurality of clients.

7. The method of claim 1, wherein maintaining peer services comprise running a media communications module of the streaming media application until the expiration.

8. A computer-readable medium having computer-executable instructions for execution by a processing system, the computer-executable instructions for randomizing termination of peer services in a peer-to-peer network, comprising:
instructions executed by a client that receive a close command;
instructions that, responsive to receiving the command, close a media player of a streaming media application;
instructions that obtain a randomized delay time; and
instructions that maintain peer services of the streaming media application until expiration of the randomized delay time.

9. The computer-readable medium of claim 8, wherein the instructions that obtain the randomized delay time comprise instructions that generate the randomized delay time.

10. The computer-readable medium of claim 8, further comprising:
instructions that establish a connection with a control server; and
instructions that generate, by the control server, the randomized delay time.

11. The computer-readable medium of claim 10, wherein the instructions that obtain the randomized delay time comprise instructions that receive the randomized delay time from the control server.

12. The computer-readable medium of claim 10, further comprising instructions that report the close command to the control server.

13. The method of claim 10, wherein the control server receives a respective close command from each of a plurality of clients running an instance of the streaming media application and generates a respective randomized delay time for each of the plurality of clients.

14. The computer-readable medium of claim 8, wherein the instructions that maintain peer services comprise media communications module instructions of the streaming media application that are run by a client until the expiration.

15. A data processing system for randomizing termination of peer services in a peer-to-peer network, comprising:
a memory that contains a streaming media application as a set of instructions;
a network adapter that interfaces with a communications medium for connecting the data processing system with peer clients in the network; and
a processing unit that, responsive to execution of the sets of instructions, receives a close command, closes a media player of the streaming media application, and maintains peer services of the streaming media application until expiration of a randomized delay time.

16. The system of claim 15, wherein the randomized delay time is generated by the streaming media application.

17. The system of claim 15, wherein the processing unit establishes a connection with a control server on the communication medium and receives the randomized delay time from the control server.

18. The system of claim 17, wherein the processing unit, response to receipt of the close command, reports the close command to the control server.

19. The system of claim 17, wherein the control server receives a respective close command from each of a plurality of clients running an instance of the streaming media application and generates a respective randomized delay time for each of the plurality of clients.

20. The system of claim 15, wherein the processing unit maintains peer services by running a media communications module of the streaming media application until the expiration.
